(19) United States
(12) Patent Application Publication
(10) Pub. No.: US 2013/0132090 A1
(43) Pub. Date: May 23, 2013

(54) Voice Data Retrieval System and Program Product Therefor

(71) Applicant: Hitachi, Ltd., Tokyo (JP)

(72) Inventor: Naoyuki KANDA, Kawasaki (JP)

(73) Assignee: Hitachi, Ltd., Tokyo (JP)

(21) Appl. No.: 13/673,444

(22) Filed: Nov. 9, 2012

(30) Foreign Application Priority Data
Nov. 18, 2011 (JP) 2011-252425

(51) Int. Cl. G10L 15/02

(52) U.S. Cl. CPC G10L 15/02
USPC 704/270.1

(57) ABSTRACT

A voice data retrieval system including an inputting device of inputting a keyword, a phoneme converting unit of converting the inputted keyword in a phoneme expression, a voice data retrieving unit of retrieving a portion of a voice data at which the keyword is spoken based on the keyword in the phoneme expression, a comparison keyword creating unit of creating a set of comparison keywords having a possibility of a confusion of a user in listening to the keyword based on a phoneme confusion matrix for each user, and a retrieval result presenting unit of presenting a retrieval result from the voice data retrieving unit and the comparison keyword from the comparison keyword creating unit to a user.

### CLAIM OF PRIORITY

The present application claims priority from Japanese patent application JP 2011-252425 filed on Nov. 18, 2011, the content of which is hereby incorporated by reference into this application.

### FIELD OF THE INVENTION

The present invention relates to a system of retrieving voice data.

### BACKGROUND OF THE INVENTION

A large amount of voice data has been accumulated in accordance with mass storage formation of a storage device in recent years. In a number of voice databases of background arts, information of time at which voice is recorded is imparted in order to manage voice data, and a desired voice data is retrieved based on the information. However, in the retrieval based on the time information, it is necessary to previously know the time at which the desired voice is spoken, which is not suitable for a use of retrieving voice in which a specific keyword is included in speech. In a case of retrieving the voice in which the specific keyword is included in the speech, it is necessary to listen to the voice from start to end.

Hence, there has been developed a technology of automatically detecting time at which a specific keyword in a voice database is spoken. According to a sub-word retrieving method which is one of representative methods, first, a voice data is converted into a sub-word sequence by sub-word recognition. Here, a sub-word is a technical term indicating a unit which is smaller than a unit of a word such as a phoneme or syllable. When a keyword is inputted, there is detected time at which the keyword is spoken in a voice data by comparing a sub-word expression of the keyword and a result of a sub-word recognition of the voice data and detecting a portion at which a degree of agreement of the sub-word and the voice data is high (Japanese Unexamined Patent Application Publication No. 2002-221984, Kohei Iwata, et al. “Verification of Effectiveness of New Sub-word Model and Sub-word Acoustic Distance in Vocabulary Free Acoustic Document Retrieving Method”, Information Processing Society of Japan Journal, Vol. 48, No. 5, 2007). According to a word spotting method shown in Tatsuya Kawahara, Toshihiko Munetsugu, Shuji Dooshita, “Word Spotting in Conversation Voice Using Heuristic Language Model”, Journal of Information & Communication Research, D-II, Information•System, II-Information Processing, Vol. 78, No. 7, pp. 1013-1020, 1995., there is detected time at which a keyword is spoken in a voice data by creating an acoustic model of the keyword by combining the acoustic model by a unit of a phoneme and checking the corresponding keyword acoustic model and the voice data.

However, any of the above-described technologies undergoes an influence of a variation in speech (provincial accent, a difference in a speaker attribute or the like) or noise, an error is included in a retrieval result, and actually, time at which the keyword is not spoken appears in the retrieval result. Therefore, a user needs to determine whether the keyword has been truly spoken by listening by reproducing a voice data from time of speaking the keyword that is provided by retrieval in order to remove an erroneous retrieval result. There is also proposed a technology for assisting the correct/incorrect determination described above. There is disclosed a technology of highlighting to reproduce time of detecting the keyword in order to determine whether the keyword is truly spoken by listening in Japanese Unexamined Patent Application Publication No. 2005-38014.

### SUMMARY OF THE INVENTION

There is disclosed the technology of highlighting to reproduce time of detecting the keyword in order to determine whether the keyword is truly spoken by listening in Japanese Unexamined Patent. Application Publication No. 2005-38014.

However, there poses a problem that difficulty is accompanied in carrying out the correct/incorrect determination as described above by listening frequently under a situation in which a language of a voice data by which a user configures a retrieval object cannot sufficiently be understood. For example, as a result of carrying out retrieval by a keyword of “play” by a user, there is a case where time at which “pray” is spoken is actually detected. In this case, there is a possibility that a Japanese user who does not sufficiently understand English determines “pray” as “play”. The above-described problem cannot be resolved by the technology of highlighting to reproduce the position of detecting the keyword as is proposed in Japanese Unexamined Patent Application Publication No. 2005-38014.

It is an object of the present invention to be able to easily carry out correct/incorrect determination of a retrieval result in a voice data retrieval system by resolving the problem.

The present invention adopts a configuration that is described in, for example, the scope of claim(s) in order to resolve the above-described problem.

As an example of a voice data retrieval system according to the present invention, there is provided a voice data retrieval system including an inputting device of inputting a keyword, a phoneme converting unit of converting the inputted keyword in a phoneme expression, a voice data retrieving unit of retrieving a portion of a voice data at which the keyword is spoken based on the keyword in the phoneme expression, a comparison keyword creating unit of creating a set of comparison keywords separately from the keyword having a possibility of a confusion of a user in listening to the keyword based on the keyword in the phoneme expression, and a retrieval result presenting unit of presenting a retrieval result from the voice data retrieving unit and the comparison keyword from the comparison keyword creating unit to the user.

When an example of a program product of the present invention is pointed out, there is provided a computer readable medium storing a program causing a computer to execute a process for functioning as a data retrieval system, the process including the steps of converting an inputted keyword in a phoneme expression, retrieving a portion of a voice data at which the keyword is spoken based on the keyword in the phoneme expression, creating a set of comparison keywords separately from the keyword having a possibility of a confusion of a user in listening to the keyword based on the keyword in the phoneme expression, and presenting a retrieval result and the comparison keyword to the user.

According to the present invention, in the voice data retrieval system, a determination of correct/incorrect of the retrieval result can easily be carried out by creating the comparison keyword set having the possibility of the confusion of the user in listening to the keyword based on the keyword inputted by the user to present to the user.

### BRIEF DESCRIPTION OF THE DRAWINGS

FIG. 1 is a block diagram showing a configuration of a computer system to which the present invention is applied;

FIG. 2 is a diagram of arranging constituent elements of the present invention in accordance with a flow of processing;

FIG. 3 is a flowchart showing the flow of the processing of the present invention;

FIG. 4 is a flowchart showing a flow of processing of creating a comparison keyword candidate;

FIG. 5 is a diagram showing an example of a word dictionary;

FIG. 6 is a diagram showing an example of a phoneme confusion matrix;

FIG. 7 is a flowchart showing a flow of processing of checking a comparison keyword candidate;

FIG. 8 is a diagram showing an example of a screen of presenting information to a user;

FIG. 9 is a diagram showing other example of a phoneme confusion matrix;

FIG. 10 is a diagram showing an example of a procedure of calculating an edit distance;

FIG. 11 is a diagram showing other example of a procedure of calculating the edit distance;

FIG. 12 is a diagram showing an example of phoneme confusion matrix in a case where a user can understand plural languages; and

FIG. 13 is a diagram showing a pseudo-code of an edit distance calculation.

### DETAILED DESCRIPTION OF THE PREFERRED EMBODIMENTS

An explanation will be given of an embodiment of the present invention in reference to attached drawings.

### First Embodiment

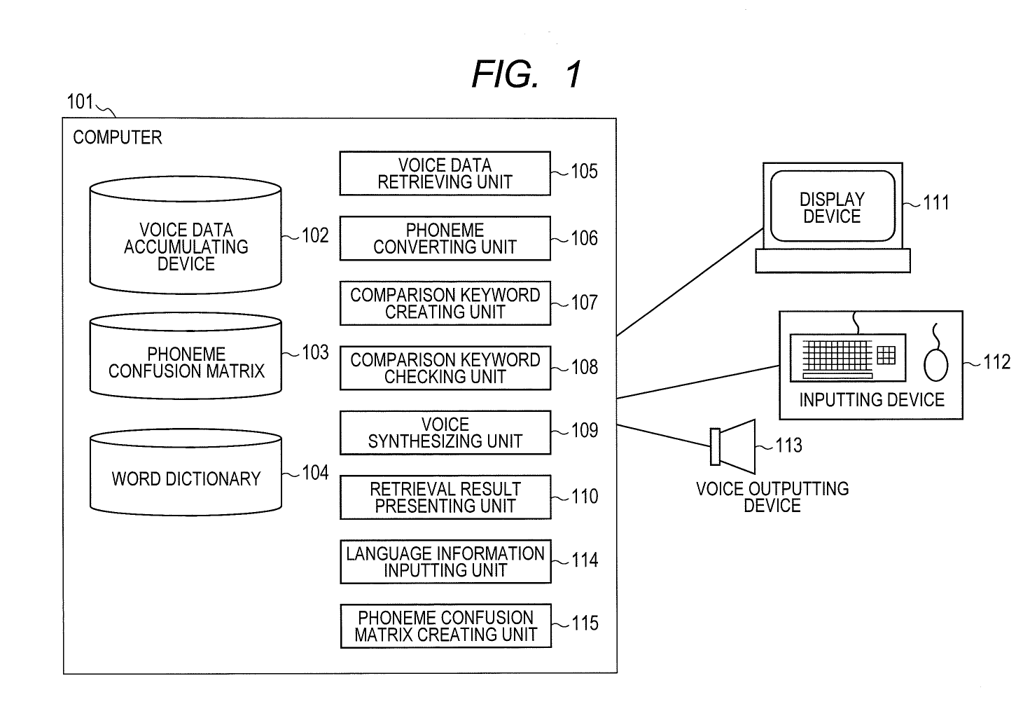

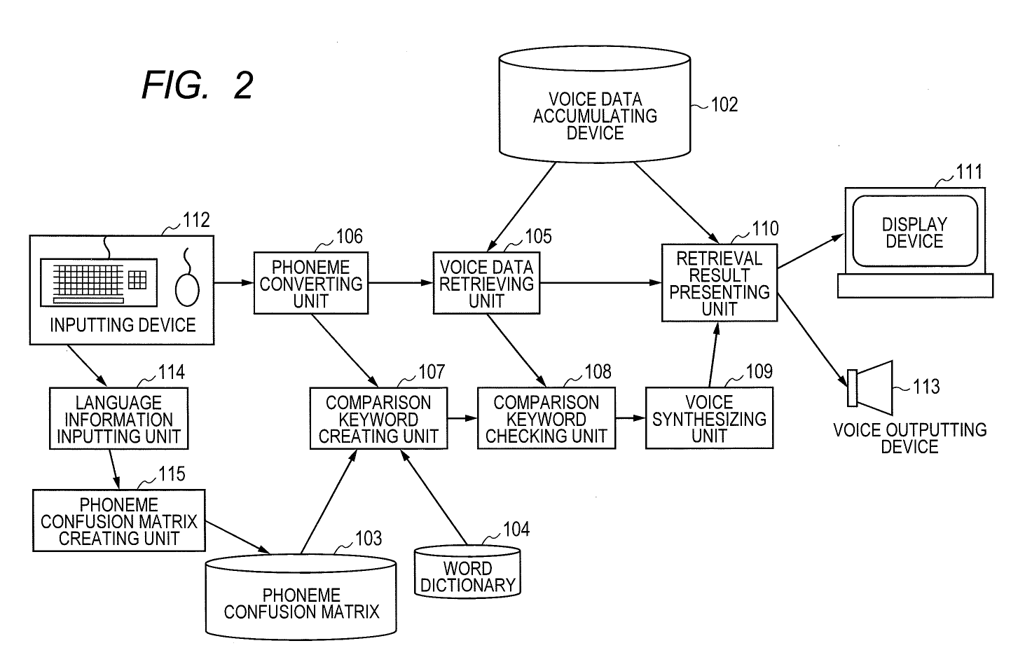

FIG. 1 is a block diagram showing a first embodiment and showing a configuration of a computer system to which the present invention is applied. FIG. 2 is a diagram arranging constituent elements of FIG. 1 in accordance with a flow of processing. A computer system of the present embodiment is configured by a computer 101, a display device 111, an inputting device 112, and a voice outputting device 113. Inside of the computer 101 includes a voice data accumulating device 102, a phoneme confusion matrix, and a word dictionary, and includes a voice retrieving unit 105, a phoneme converting unit 106, a comparison keyword creating unit 107, a comparison keyword checking unit 108, a voice synthesizing unit 109, a retrieval result presenting unit 110, a language information inputting unit 114, and a phoneme confusion matrix creating unit 115.

A voice data retrieval system can be realized by loading a prescribed program onto a memory by CPU, and executing the prescribed program loaded onto the memory by CPU in a computer. The prescribed program may be loaded directly onto the memory by inputting the prescribed program from a storage medium stored with the program via a reading device, or from a network via a communication device, or may be loaded onto the memory after storing the prescribed program once to an external storage device, although not illustrated.

The present invention of a program product according to the present invention is a program product which is integrated to a computer in this way and operating the computer as a voice data retrieval system. A voice data retrieval system shown in the block diagrams of FIG. 1 and FIG. 2 is configured by integrating the program product of the present invention to the computer.

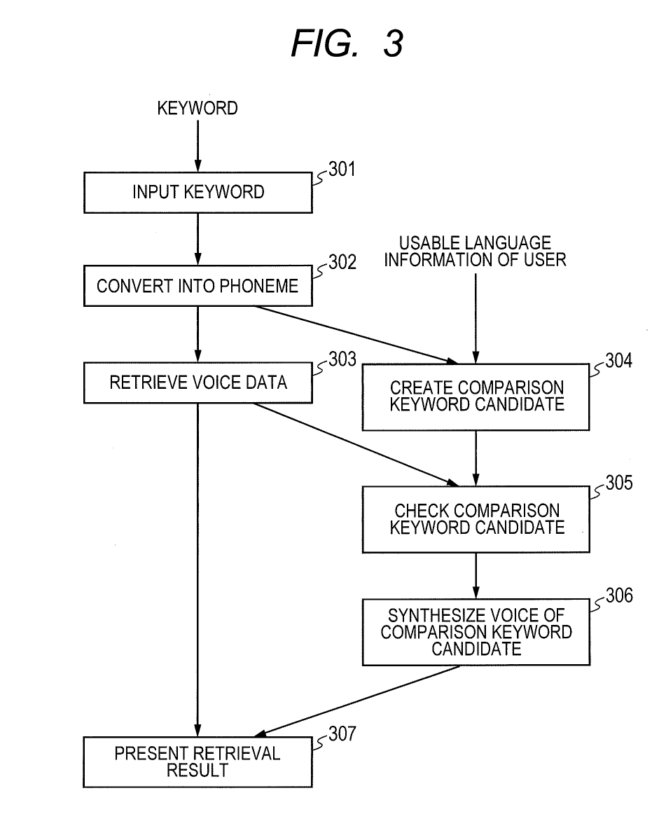

A description will be given as follows of a flow of processing of respective constituent elements. FIG. 3 shows a flowchart of processing.

### [Keyword Input and Conversion to Phoneme Expression]

When a user inputs a keyword from the inputting device 112 (processing 301) in text, first, the phoneme converting unit 106 converts the keyword in a phoneme expression (processing 302). For example, in a case where the user inputs a keyword of “play” as an input, “play” is converted into “pleI”. The conversion is known as a morpheme analyzing processing, which is well known for the skilled person, and therefore, an explanation thereof will be omitted.

A keyword can also be inputted by speaking the keyword to a microphone by voice of a user by using the microphone as an inputting device. In this case, a voice waveform can be converted into a phoneme expression by utilizing a speech recognition technology as a phoneme converting unit.

### [Voice Data Retrieval]

Successively, the voice data retrieving unit 105 detects time at which the keyword is spoken in voice data accumulated in the voice data accumulating device 102 (processing 303). In the processing, there can be used a word spotting processing presented in, for example, Tatsuya Kawahara, Toshihiko Munetsugu, Shuji Dooshita, “Word Spotting in Conversation Voice Using Heuristic Language Model”, Journal of Information & Communication Research, D-II, Information•System, II-Information Processing, Vol. 78, No. 7, pp. 1013-1020, 1995. Or, there can also be used a method of previously pretreating a voice data accumulating device as in Japanese Unexamined Patent Application Publication No. 2002-221984, Kohei Iwata, et al. “Verification of Effectiveness of New Sub-word Model and Sub-word Acoustic Distance in Vocabulary Free Acoustic Document Retrieving Method”, Information Processing Society of Japan Journal, Vol. 48, No. 5, 2007 or the like. An enterprise person may select any of the means.

### [Creation of Comparison Keyword Candidate]

Successively, the comparison keyword creating unit 107 creates a comparison keyword set having a possibility of being confused in listening by a user (processing 304). In the following explanation, a keyword is inputted in English; on the other hand, a user speaks Japanese as a native language. However, a language of a keyword and a language of a user are not limited to English and Japanese, and any combination of languages will do.

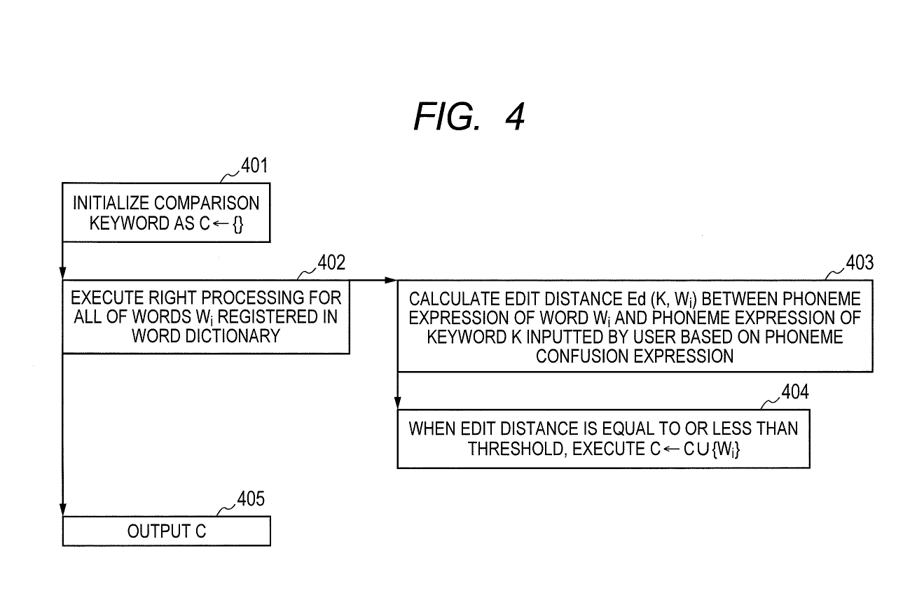

FIG. 4 shows a flow of processing. First, a comparison keyword set C is initialized as an empty set (processing 401). Successively, with regard to all of words Wᵢ which are registered in an English word dictionary, there are calculated edit distances Ed (K, Wᵢ) between phoneme expressions of the words Wᵢ and a phoneme expression of a keyword K that is inputted by a user (processing 403). When the edit distance for the word Wᵢ is equal to or less than a threshold, the corresponding word is added to the comparison keyword set C (processing 404). Finally, the comparison keyword set C is outputted.

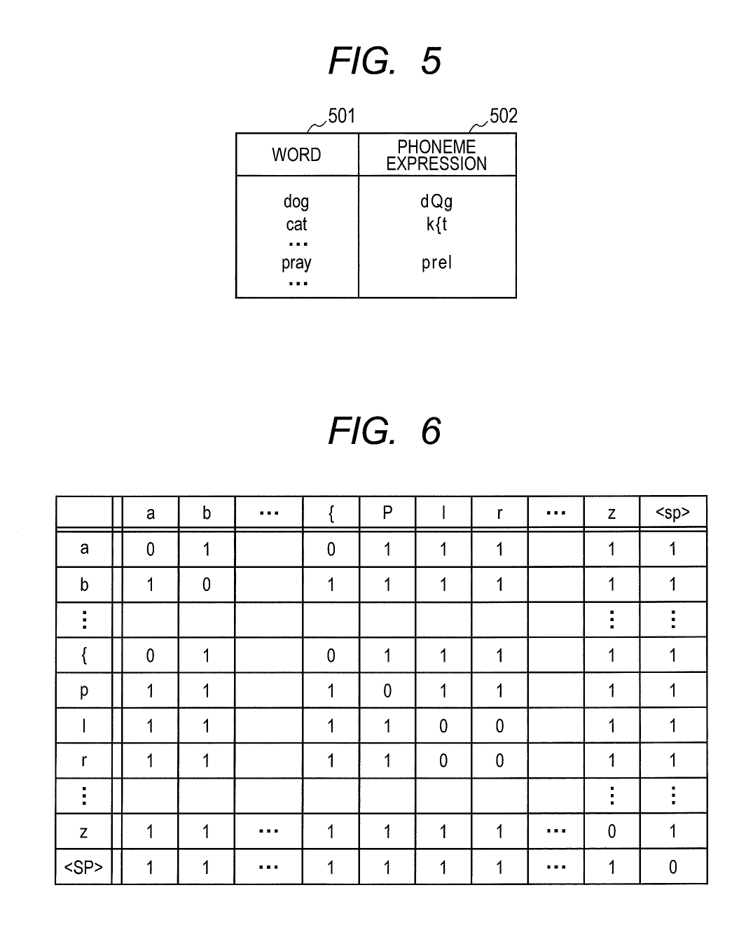

FIG. 5 shows an example of a word dictionary. As shown in FIG. 5, the word dictionary is described with a number of sets of words 501 and phoneme expressions of the words 502.

FIG. 6 shows an example of a phoneme confusion matrix for Japanese speaker. According to the phoneme confusion matrix, in a case where a phoneme shown in a vertical column is easy to be confused by a phoneme shown in a horizontal column, a value near to 0 is described, and in a case where the phoneme shown in the vertical column is difficult to be confused by the phoneme shown in the horizontal column, a value near to 1 is described both by numerical values from 0 to 1. However, notation SP designates a special notation expressing “silence”. For example, a phoneme b is difficult to be confused by a phoneme a, and therefore, 1 is assigned in the phoneme confusion matrix. In contrast thereto, a phoneme l and a phoneme r are phonemes which are easy to be confused by each other for a user having a native language of Japanese, and therefore, a value of 0 is assigned in the phoneme confusion matrix. In a case where phonemes are the same as each other, 0 is always assigned. One phoneme confusion matrix is prepared for each native language of a user. In the following, in a phoneme confusion matrix, a value assigned to a row of phoneme X and a column of phoneme Y is expressed as Matrix (X, Y).

An edit distance defines a distance scale between a certain character string A and a character string B, and is defined as a minimum operation cost for converting the character string A into the character string B by subjecting the character string A to respective operations of substitution, insertion, and deletion. For example, when the character string A is abcde and the character string B is acfeg as shown in FIG. 10, the character string A can be converted into the character string B by first, deleting b at a second character of the character string A, substituting d at a fourth character of the character string A for f, and adding g to a tail end of the character string A. Here, costs taken for the substitution, the insertion, and the deletion are respectively defined, and an edit distance Ed (A, B) is made to be a sum of operation costs when operations minimizing the sum of the operation costs are selected.

According to the embodiment, a cost taken for inserting a certain phoneme X is made to be Matrix (SP, X), a cost taken for deleting a certain phoneme X is made to be Matrix (X, SP), and a cost of substituting a phoneme X for a phoneme Y is made to be Matrix (X, Y). Thereby, the edit distance which reflects a phoneme confusion matrix can be calculated. For example, consider a case of calculating an edit distance between a phoneme expression “pleI” of a keyword “play” and a phoneme expression “preI” of a word “pray” in accordance with the phoneme confusion matrix of FIG. 6. “pleI” can be converted into “preI” by substituting a second character of “pleI” for r. Here, a value of 0 is assigned to l and r in the phoneme confusion matrix of FIG. 6. Therefore, a cost Matrix (l, r) of substituting l for r is 0. Therefore, “pleI” can be converted into “preI” at cost of 0. Therefore, an edit distance is calculated as Ed (play, pray)=0.

Incidentally, a dynamic programming which is an efficient method of calculating an edit distance is well known for the skilled person, and therefore, only a pseudo-code is shown here. FIG. 13 shows a pseudo-code. Here, a phoneme at an i-th character of a phoneme sequence A is expressed as A (i), and lengths of the phoneme sequence A and a phoneme sequence B are respectively made to be N and M.

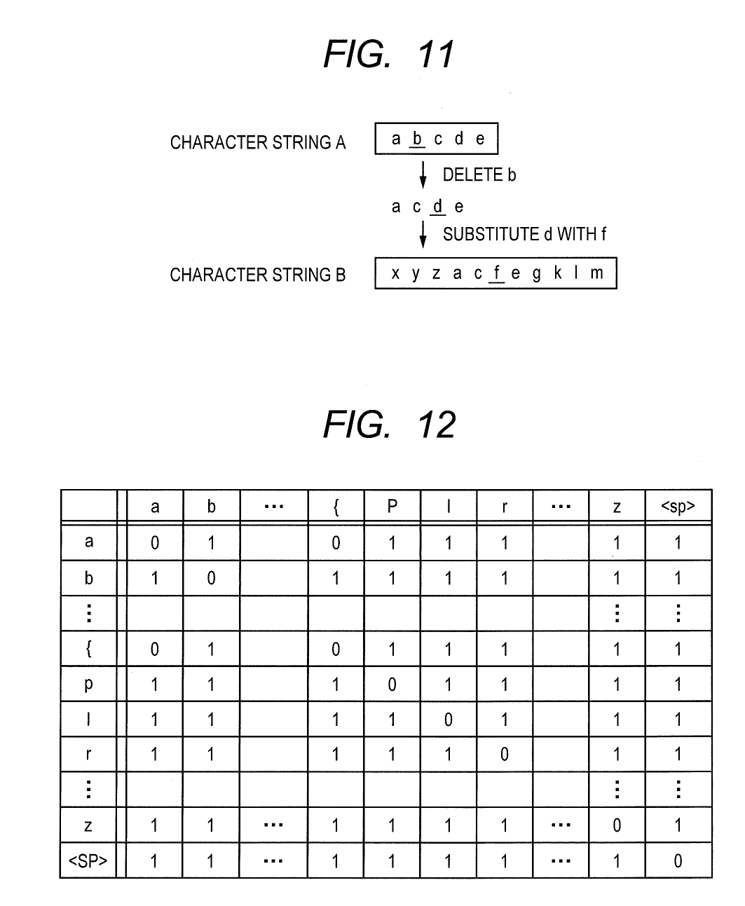

As a definition of an edit distance separately from the above-described, an edit distance can also be defined as a minimum operation cost for including a character string A as operated in a character string B by subjecting the character string A to respective operations of substitution, insertion, and deletion. For example, in a case where a character string A is abcde, and a character string B is xyzacfegklm as shown in FIG. 11, first, b at a second character of the character string A is deleted, successively, a character d at a third character of acde is substituted for f, thereby, the character string acfe as operated is included in the character string B. A sum of operation costs at this occasion is made to be an edit distance Ed (A, B).

In creating a comparison keyword, either of 2 kinds described above may be used as a definition of an edit distance. Any method can be utilized so far as the method is a method of measuring a distance between character strings other than the processes described above.

Not only a word Wᵢ but a word sequence W₁ . . . W_{N} may be used in processes 403 and 404 of FIG. 4.

There can be carried out packaging in which in processing 403, not only an edit distance Ed (K, W₁ . . . W_{N}) but a probability P (W₁ . . . W_{N}) of creating a word sequence W₁ . . . W_{N} are calculated in processing 403, and in processing 404, when the edit distance is equal to or less than the threshold, and P (W₁ . . . W_{N}) is equal to or more than a threshold, C←C U {W₁ . . . W_{N}}. In this case, a comparison keyword set also includes the word sequence. Incidentally, as a method of calculating P (W₁ . . . W_{N}), for example, an N-gram model which is well known in a field of a language processing can be utilized. Details of the N-gram model are well known for the skilled person, and therefore, an explanation thereof will be omitted here.

There can also be utilized an arbitrary scale of combining Ed (K, W₁ . . . W_{N}) and P (W₁ . . . W_{N}) other than the above-described. For example, in processing 404, there can be utilized the scale of Ed (K, W₁ . . . W_{N})/P (W₁ . . . W_{N}) or (P (W₁ . . . W_{N})*(length (K)−Ed (K, W₁ . . . W_{N}))/length (K). Incidentally, length (K) is a number of phonemes included in a phoneme expression of keyword K.

### [Creation of Phoneme Confusion Matrix]

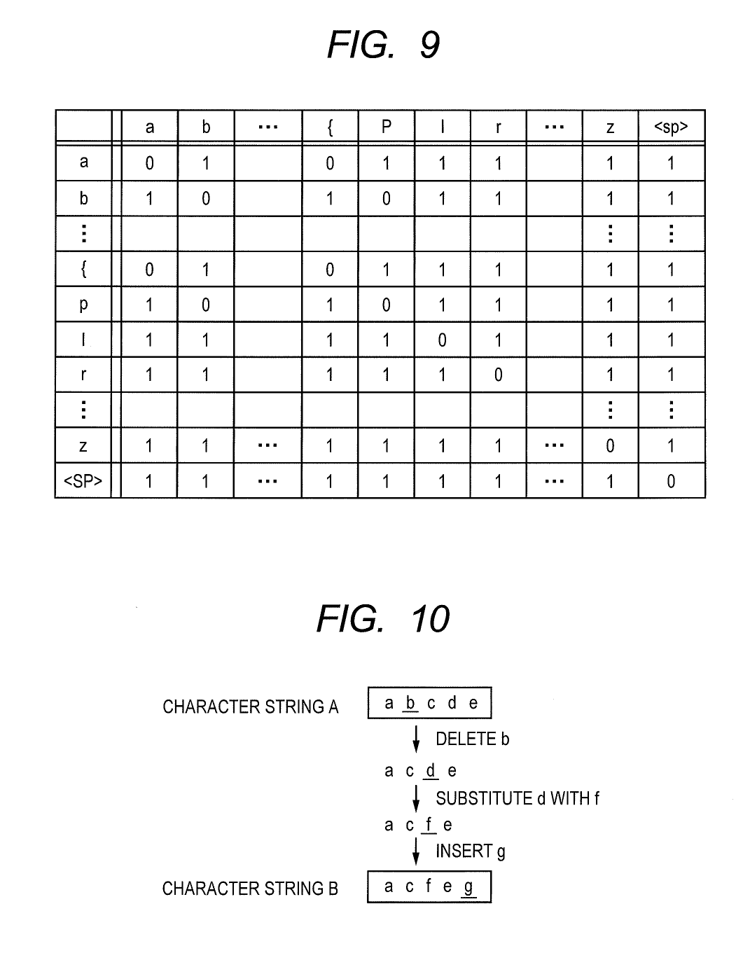

A phoneme confusion matrix which is used for creating a comparison keyword can be switched by a native language or a usable language of a user. In this case, a user inputs information with regard to a native language or a useable language of the user to a system via the language information inputting unit 114. In the system which receives an input from the user, the phoneme confusion matrix creating unit 115 outputs a phoneme confusion matrix for the native language of the user. For example, although FIG. 6 is for a Japanese speaker, a phoneme confusion matrix as shown in FIG. 9 can be used for a user having a native language of Chinese. For example, in FIG. 9, different from FIG. 6, a point of intersecting a phoneme l and a phoneme r is indicated by 1, and there is configured a definition that the two phonemes are difficult to be confused by each other by a user having the native language of Chinese.

The phoneme confusion matrix creating unit is not limited to a native language of a user but can switch a phoneme confusion matrix by information of a language which the user can understand.

In a case where a user can understand plural languages, the phoneme confusion matrix creating unit 115 can also create a phoneme confusion matrix which combines these pieces of the language information. As one of embodiments, for a user who can understand α language and β language, there can be created a confusion matrix i row j column element of which is configured by a larger one of i row j column element of a phoneme confusion matrix for an α language user and i row j column element of a phoneme confusion matrix for a β language user. Also in a case where a user can understand languages of 3 languages or more, there may be selected the largest one of i row j column elements for respective matrix elements in phoneme confusion matrices of respective languages.

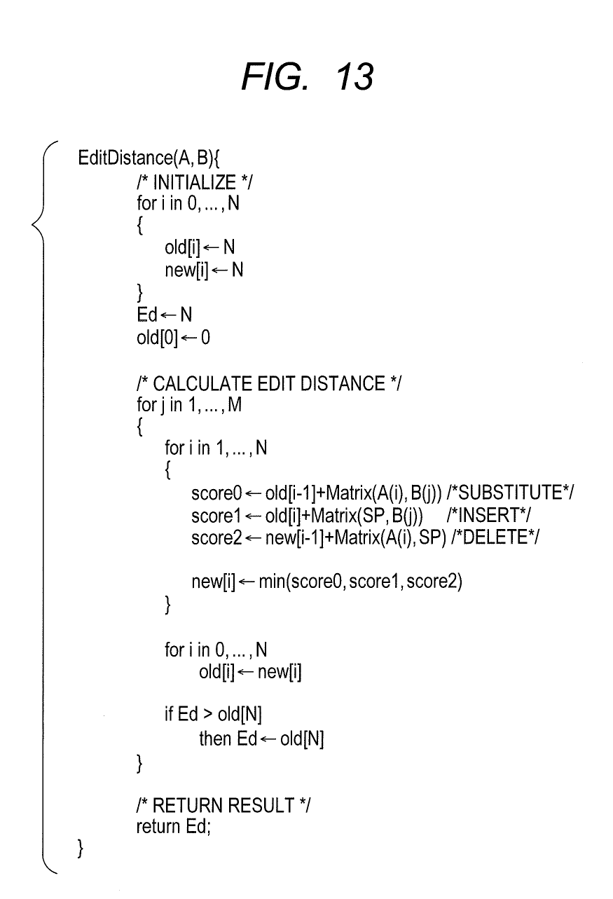

For example, for a user who can understand Japanese and Chinese, a phoneme confusion matrix of FIG. 12 is created. In respective elements of the phoneme confusion matrix of FIG. 12, the respective elements are substituted for larger ones of respective matrix elements of the phoneme confusion matrix for a Japanese speaker (FIG. 6) and the phoneme confusion matrix for a Chinese speaker (FIG. 9).

A user can also adjust a value of a phoneme confusion matrix by directly operating the matrix.

Incidentally, creation of a phoneme confusion matrix can be carried out at an arbitrary timing before operating the comparison keyword creating unit.

### [Check of Comparison Keyword Candidate]

It is selected whether the corresponding comparison keyword is to be presented to a user for comparison keyword candidates that are created by the comparison keyword creating unit 107 by operating the comparison keyword checking unit 108. An unnecessary comparison keyword candidate is removed thereby.

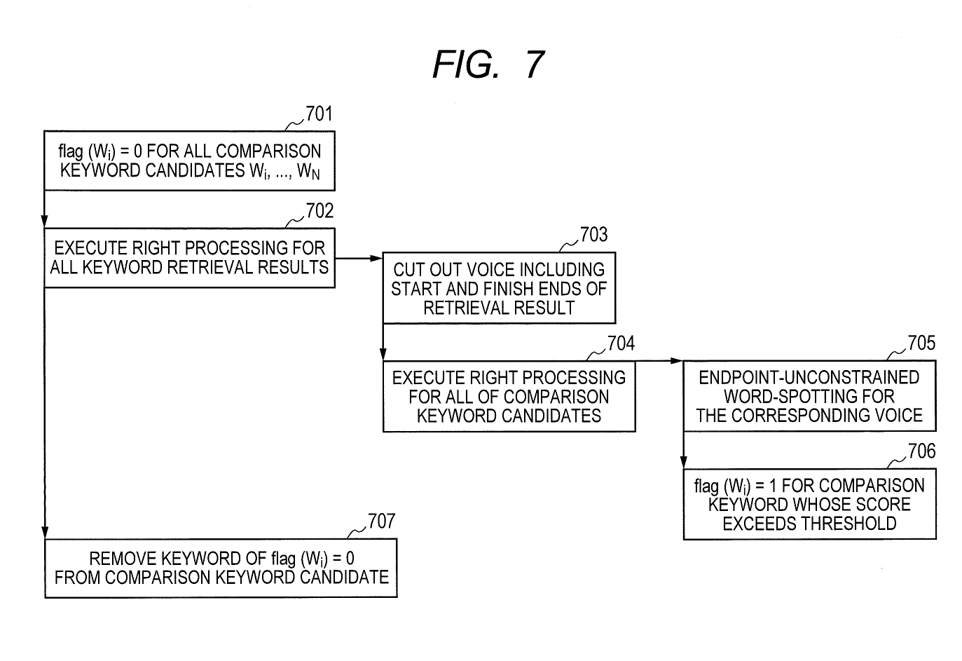

FIG. 7 shows a flow of the processing.
(1) First, execute flag (W₁)=0 with regard to all of comparison keyword candidates Wᵢ (i=1, . . . , N) created by the comparison keyword creating unit 107 (processing 701).
(2) Successively, execute processes of (i) through (iii) as follows for all of candidates of time of speaking a keyword provided from the voice data retrieving unit.

(i) Cut out voice X including start and finish ends of time of speaking the keyword (processing 703).

(ii) Execute a word spotting processing for the voice with regard to all of comparison keyword candidates Wᵢ (i=1, . . . , N) (processing 705).

(iii) Execute flag (Wᵢ)=1 for a word Wᵢ in which score P*(Wᵢ*|X) provided as a result of the word spotting exceeds a threshold (processing 706).
(3) Remove a keyword in which flag (Wᵢ) is 0 from the comparison keyword candidates (processing 707).

Incidentally, in the word spotting processing, there is calculated a probability P (*key*|X) for speaking a keyword Wᵢ in voice X in accordance with Equation 1.

$$P (* key *) ≅ {max}_{{h}_{0}} P ( X \vert {h}_{0} ) P ( {h}_{0} ) / ( {max}_{{h}_{1}} P ( X \vert {h}_{1} ) P ( {h}_{1} ) ) \qquad Equation 1$$

Here, notation h₀ designates an element which includes a phoneme expression of the keyword in an arbitrary phoneme set, and notation h₁ designates an element of an arbitrary phoneme sequence set. Details thereof are shown in Tatsuya Kawahara, Toshihiko Munetsugu, Shuji Dooshita, “Word Spotting in Conversation Voice Using Heuristic Language Model”, Journal of Information & Communication Research, D-II, Information•System, II-Information Processing, Vol. 78, No. 7, pp. 1013-1020, 1995 or the like, the details are well known for the skilled person, and therefore, here, a further explanation thereof will be omitted.

In a case where a value P (*W*|X) of the word spotting which is calculated in checking a comparison keyword exceeds a threshold, the corresponding retrieval result can also be removed from a retrieval result.

Incidentally, a processing of checking a comparison keyword candidate may be omitted.

### [Voice Synthesizing Processing]

Both of the voice comparison keyword candidate and the keyword inputted by the user are converted into voice waveforms by the voice synthesizing unit 109. Here, a voice synthesizing technology of converting a text into a voice waveform is well known for the skilled person, and therefore, details thereof will be omitted.

### [Presentation of Retrieval Result]

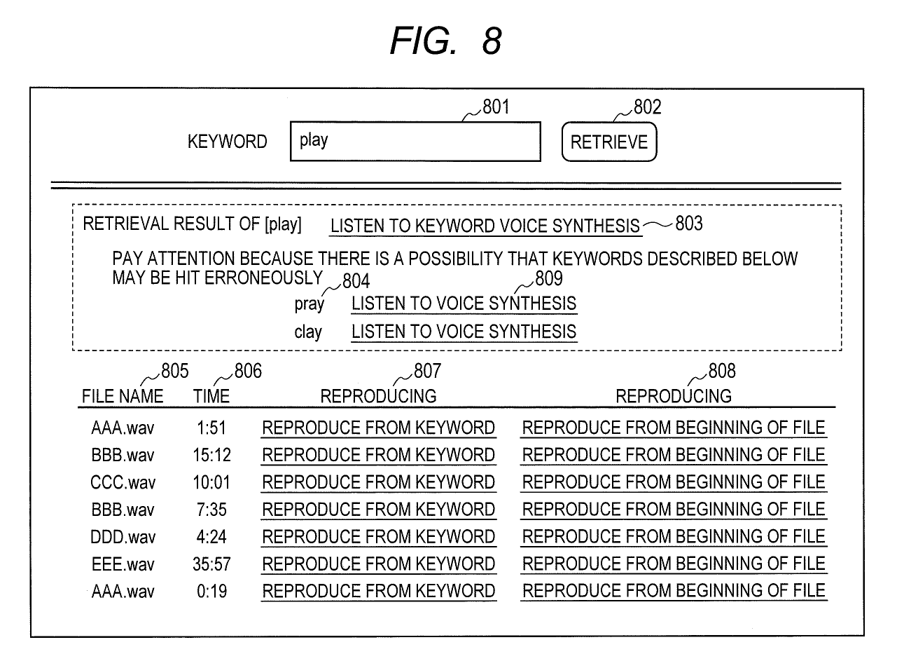

Finally, the retrieval result presenting unit 110 presents information with regard to a retrieval result and a comparison keyword to a user via the display device 111 and the voice outputting device 113. FIG. 8 shows an example of a screen displayed on the display device 111 at this occasion.

A user can retrieve a portion at which the keyword is spoken in a voice date accumulated in the voice data accumulating device 102 by inputting a retrieval keyword to a retrieval window 801 and pressing down a button 802. In an example of FIG. 8, a user retrieves a portion at which a keyword of “play” is spoken in a voice data accumulated in the voice data accumulating device 102.

The retrieval result is a voice file name 805 in which the keyword inputted by the user is spoken and time 806 at which the keyword is spoken in the voice file, and voice is reproduced via the voice outputting device 113 from the time of the file by clicking a portion of “reproduce from keyword” 807. Also, voice is reproduced by the voice outputting device 113 from the start of the file by clicking a portion of “reproduce from start of file” 808.

A voice synthesis of the keyword is reproduced via the voice outputting device 113 by clicking a portion of “listen to keyword voice synthesis” 803. Thereby, the user can listen to a correct pronunciation of the keyword, which can configure a reference of whether the retrieval result is correct.

As candidates of the comparison keyword, pray and clay are displayed at 804 of FIG. 8, and voice syntheses of pray and clay are reproduced via the voice outputting device 113 by clicking a portion of “listen to voice synthesis” 809. Thereby, a user notices a possibility of erroneously detecting portions at which keywords of “pray” and “clay” are spoken as a retrieval result, and the user can configure a reference when it is determined whether the retrieval result is correct by listening to synthesized voice of the comparison keyword.

What is claimed is:

1. A voice data retrieval system comprising:
an inputting device of inputting a keyword;
a phoneme converting unit of converting the inputted keyword in a phoneme expression;
a voice data retrieving unit of retrieving a portion of a voice data at which the keyword is spoken based on the keyword in the phoneme expression;
a comparison keyword creating unit of creating a set of comparison keywords separately from the keyword having a possibility of a confusion of a user in listening to the keyword based on the keyword in the phoneme expression; and
a retrieval result presenting unit of presenting a retrieval result from the voice data retrieving unit and the comparison keyword from the comparison keyword creating unit to the user.

2. The voice data retrieval system according to claim 1, further comprising:
a phoneme confusion matrix for each user;
wherein the comparison keyword creating unit creates the comparison keyword based on the phoneme confusion matrix.

3. The voice data retrieval system according to claim 2, further comprising:
a language information inputting unit of inputting a piece of information of a language which the user can understand; and
a phoneme confusion matrix creating unit of creating the phoneme confusion matrix based on the piece of information provided from the language information inputting unit.

4. The voice data retrieval system according to claim 1, wherein the comparison keyword creating unit calculates an edit distance between the keyword in the phoneme expression and a phoneme expression of a word registered in a word dictionary, and determines the word having the edit distance equal to or less than a threshold to be the comparison keyword.

5. The voice retrieval system according to claim 1, further comprising:
a voice synthesizing unit of synthesizing a voice(s) of either one or both of the keyword inputted by the user and the comparison keyword created by the comparison keyword creating unit,
wherein the retrieval result presenting unit presents a synthesized voice from the voice synthesizing unit to the user.

6. The voice data retrieval system according to claim 1, further comprising:
a comparison keyword checking unit of removing an unnecessary comparison keyword candidate by comparing a comparison keyword candidate created by the comparison keyword creating unit and the retrieval result of the voice data retrieving unit.

7. The voice data retrieval system according to claim 6, wherein the comparison keyword checking unit removes the unnecessary voice data retrieval result by comparing the comparison keyword candidate and the retrieval result of the voice data retrieving unit.

8. A computer readable medium storing a program causing a computer to execute a process for functioning as a voice data retrieval system, the process comprising:
converting an inputted keyword in a phoneme expression;
retrieving a portion of a voice data at which the keyword is spoken based on the keyword in the phoneme expression;
creating a set of comparison keywords separately from the keyword having a possibility of a confusion of a user in listening to the keyword based on the keyword in the phoneme expression; and
presenting a retrieval result and the comparison keyword to the user.

9. The computer readable medium according to claim 8 storing the program causing the computer to execute the process for functioning as the voice data retrieval system, the process further comprising:
creating a comparison keyword based on a phoneme confusion matrix.

10. The computer readable medium according to claim 9 storing the program causing the computer to execute the process for functioning as the voice data retrieval system, the process further comprising:
inputting a piece of information of a language which the user can understand; and
creating the phoneme confusion matrix based on the piece of information.

11. The computer readable medium according to claim 8 storing the program causing the computer to execute the process for functioning as the voice data retrieval system, the process further comprising:
calculating an edit distance between the keyword in the phoneme expression and a phoneme expression of a word registered in a word dictionary; and
making a word having the edit distance equal to or less than the threshold function as a comparison keyword.

12. The computer readable medium according to claim 8 storing the program causing the computer to execute the process for functioning as the voice data retrieval system, the process further comprising:
synthesizing a voice(s) of either one or both of the keyword inputted by the user and the comparison keyword; and
presenting a synthesized voice to the user.

13. The computer readable medium according to claim 8 storing the program causing the computer to execute the process for functioning as the voice data retrieval system, the process further comprising:
comparing a comparison keyword candidate and a retrieval result; and
removing an unnecessary comparison keyword candidate.

14. The computer readable medium according to claim 13 storing the program causing the computer to execute the process for functioning as the voice data retrieval system, the process further comprising:
removing the unnecessary voice data retrieval result by comparing the comparison keyword candidate and the retrieval result.
